(19) United States
(12) Patent Application Publication
(10) Pub. No.: US 2015/0012739 A1
(43) Pub. Date: Jan. 8, 2015

(54) SWITCHING OF OPERATING SYSTEMS

(71) Applicants: Zi-Jiang Yang, Shanghai (CN); Yi-Qun Ren, Shanghai (CN)

(72) Inventors: Zi-Jiang Yang, Shanghai (CN); Yi-Qun Ren, Shanghai (CN)

(21) Appl. No.: 14/371,506

(22) PCT Filed: Apr. 25, 2012
(86) PCT No.: PCT/CN2012/074648

§ 371 Date: Jul. 10, 2014

(51) Int. Cl. G06F 9/50

(52) U.S. Cl. CPC G06F 9/50
USPC 713/100

(57) ABSTRACT

Switching from a first operating system to a second operating system by re-using components that are common to the first operating system and the second operating system. The common components can be for example a kernel, file systems, drivers, protocol stack and the like.

### BACKGROUND

An operating system (OS) can represent a monolithic application that consumes a substantial amount of memory and processing power. While many PCs and notebook computers are capable of the necessary memory and processing power to employ the ever-growing functionality of operating systems (OSs), many mobile devices are not capable to efficiently manage such resources for processing multiple OSs.

It is now possible to achieve multi-function applications via implementing different OSs, such as when using different applications. With the computer multi-OS application popularized, efficiency on the time employed for switching between multi-OSs in a computing unit becomes of significant importance.

### BRIEF DESCRIPTION OF THE DRAWINGS

FIG. 1 illustrates an example of a block diagram for a non-limiting system that facilitates switching among multiple operating systems.

FIG. 2 illustrates an example of Linux™ kernel that interacts with a switching component in accordance with an aspect of the subject disclosure.

FIG. 3 illustrates an example block diagram for a switching component according to a further aspect of the subject disclosure.

FIG. 4 illustrates an example for change of root directory and file system name space switching.

FIG. 5 illustrates an example methodology of switching between operating systems according to an aspect of the subject disclosure.

FIG. 6 illustrates an example methodology of identifying and re-using components that are common between the operating systems for a switching therebetween.

FIG. 7 illustrates an example inference component that can interact with a switching component of the subject disclosure.

FIG. 8 illustrates a schematic diagram that represents an example for a networked or distributed computing environment in which embodiments described herein can be implemented.

FIG. 9 illustrates an example of a suitable computing environment in which aspects described herein can be implemented.

### DETAILED DESCRIPTION

Oftentimes a user of the computing unit may select a specific operating system (OS) at startup or boot. Such multi-OS feature can be desired as a function of employing applications or merely user preferences. For example, situations can routinely occur where a specific OS is required to run a computer application. Furthermore, users can demonstrate a strong preference for employing an OS, because such OS has proven strong functionalities and user have become skilled in using their associated features.

Moreover, it is possible to use multiple OSs on a single computer by changing the boot loader to allow a user to select the operating system desired to be run at boot time. Nonetheless, rebooting can remain slow. It is also possible to use multiple OSs on a single computer by using virtualization to run multiple guest operating systems on top of a single host operating system. However, virtualization does not often allow each OS direct access to hardware devices, which can reduce performance, for programs that require direct access to high speed peripherals, such as games.

Several embodiments are now described with reference to the drawings, wherein like reference numerals are used to refer to like elements throughout. In the following description, for purposes of explanation, numerous specific details are set forth in order to provide a more thorough understanding of one or more embodiments. It is evident, however, that such embodiments can be practiced without these specific details. In other instances, structures and devices are shown in block diagram form in order to facilitate describing one or more embodiments.

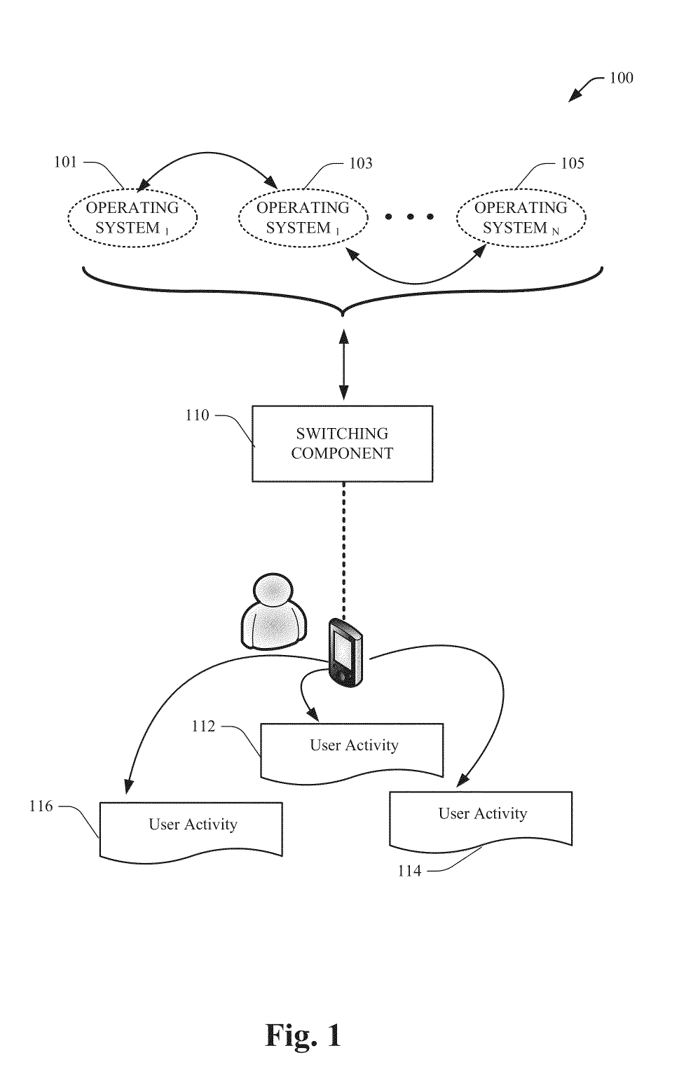

Various aspects of the subject disclosure facilitate switching processes among multiple operating systems, by re-using components that are common to such multiple operating systems (e.g., reusing a kernel, file systems, drivers, protocol stack and the like). FIG. 1 illustrates a block diagram 100 for a switching component 110 that facilitates switching processes among a plurality of operating systems 101, 103, 105 (where N is an integer), by re-using components that are common therebetween. Such common re-usable components can relate to: reusing a kernel, file systems, drivers, protocol stack and the like. The switching among the operating systems 101, 103, 105 can occur based on activities 112, 114, 116 that a user is engaged in when employing a computing unit having the operating systems 101, 103, 105.

Any of the operating systems 101, 103, 105 can be considered primarily suitable for specific tasks. For example, Android™ (a Linux™-kernel based OS) may be considered well designed for internet surfing, web-service accessing, touch experience, and relatively low power consumption. Nonetheless, Android™ can suffer from poor window management and lack of sufficient offline applications. On the other hand, Ubuntu™ (another Linux™-kernel based OS) can provide rich offline applications (e.g., OpenOffice™) and flexible multi-window management.

Yet, Ubuntu™ may not supply efficient touch experience and power savings. By selectively combining benefits of the two operating systems, the subject disclosure enables a user to switch (e.g., back and forth) between these OS's based on type of activity that the user is engaged in (e.g., employing Android™ for web surfing). Likewise, some applications employ specific Linux™ OS, such as accessing bank accounts that use USB certificate—which remains feasible for Linux™ OS. Hence, a user who surfs the internet on Android™ can benefit when switching to Ubuntu™ for bill payment, and switch back to Android™ to surf the web again. Hence, the switching component 110 enables a computing unit to selectively benefit from features of both operating systems, depending on type of activity that the user becomes engaged in, for example.

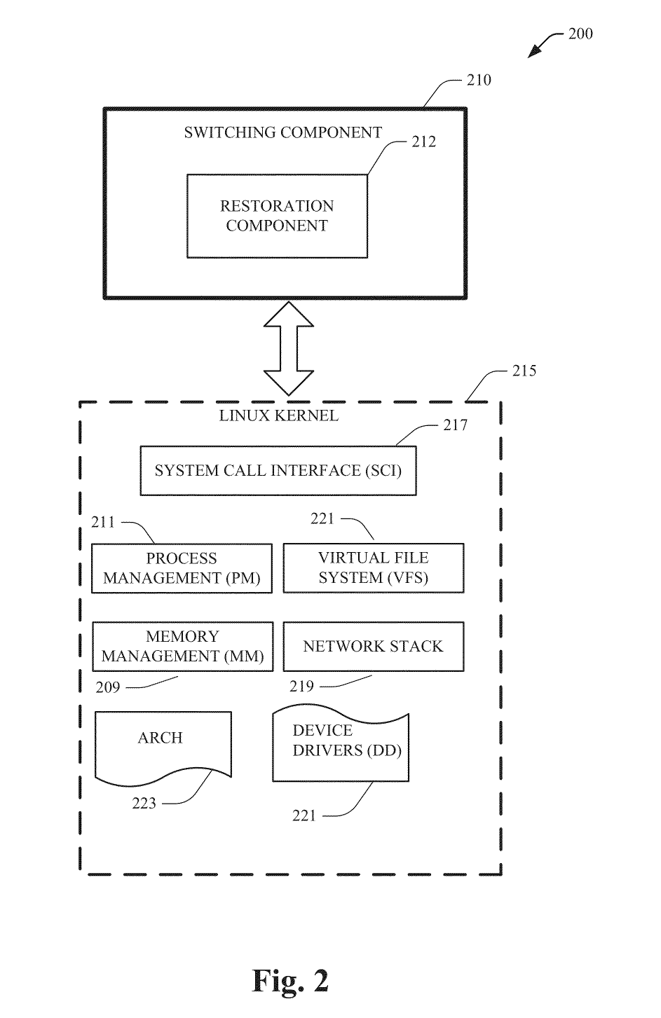

FIG. 2 illustrates a switching component 210 in accordance with the subject disclosure, which interacts with a kernel (e.g., Linux™). In one aspect, the switching component 210 further includes a restoration component 212 that can both save and restore the environment variables that are associated with switching of operating systems having the same kernel, such as the Linux™ kernel 215. For example, the restoration component 212 can save the system environment variables, wherein such saved environment variables can subsequently be employed by the run time environment, to facilitate switching back to the original or first OS.

The Linux™ kernel 215 itself can include a number of components wherein basic services can be aggregated as a monolithic arrangement, for example. Such an arrangement can include a System Call Interface (SCI) 217 that can perform function calls (e.g., multiplexing and/or de-multiplexing) from user space into the kernel. It is to be noted that such interface can be architecture dependent, even within the same processor family.

Likewise, the process management 211 can facilitate execution of processes, such as threads that can further represent an individual virtualization of the processor (thread code, data, stack, and CPU registers). The Linux™ kernel 215 can further provide an application program interface (API) through the SCI 217 to create a new process (fork, exec, or Portable Operating System Interface [POSIX] functions), stop a process (kill, exit), and communicate and synchronize between such processes (signal, or POSIX mechanisms).

The Linux™ kernel 215 can further implement processes that operate in constant time, regardless of the number of threads vying for the CPU (e.g., O(1) scheduler). Likewise, memory management 209 can employ an arrangement scheme to dynamically grow and shrink based on the needs of the greater system.

For example, supporting multiple users of memory, there are times when the available memory can be exhausted. Hence, by swapping pages between memory and onto the disk, resources can be efficiently managed (e.g., employing 4KB buffers at a base, and allocating structures from within—while maintaining track of which pages are full, partially used, and empty.)

In addition, virtual file system (VFS) 221 can provide a common interface abstraction for file systems. The VFS 221 can further provide a switching layer between the SCI 217, and the file systems supported by the Linux™ kernel 215.

Moreover, positioned at top of the VFS 221 can be placed a common API abstraction of functions (not shown) such as open, close, read, and write. Similarly and at the bottom of the VFS 221, the file system abstractions can be positioned, which define how the upper-layer functions can be implemented. Such can represent plug-ins for the given file system, for example. Positioned below the file system layer can be placed a buffer cache (not shown), which provides a common set of functions to the file system layer (independent of any file system). Such caching layer optimizes access to the physical devices by keeping data available for a relatively short period (or speculatively read ahead, so that such data remains available when called upon). Moreover, below the buffer cache are the device drivers, which implement the interface for the physical device.

The network stack 219 can be designed as a layered architecture that can modeled after the protocols themselves (e.g., the Internet Protocol representing the core network layer protocol that lies below the transport protocol, such as the Transmission Control Protocol, or TCP), and above the TCP is the sockets layer, which can be invoked through the SCI 217. The sockets layer can represent standard API to the networking subsystem and provides a user interface to a variety of networking protocols. Hence, from raw frame access to IP protocol data units (PDUs) and up to TCP and the User Datagram Protocol (UDP), the sockets layer can provide a standardized way to manage connections and move data between endpoints.

In addition, a vast majority of the source code in the Linux™ kernel 215 can exist in device drivers that enable a hardware device usable. For example, the Linux™ source tree can provide a drivers subdirectory, which is further divided by various devices that are supported, such as Bluetooth, I2C, serial, and so on. In addition, the arch subdirectory 223 defines the architecture-dependent portion of the kernel source contained in a number of subdirectories that are specific to the architecture.

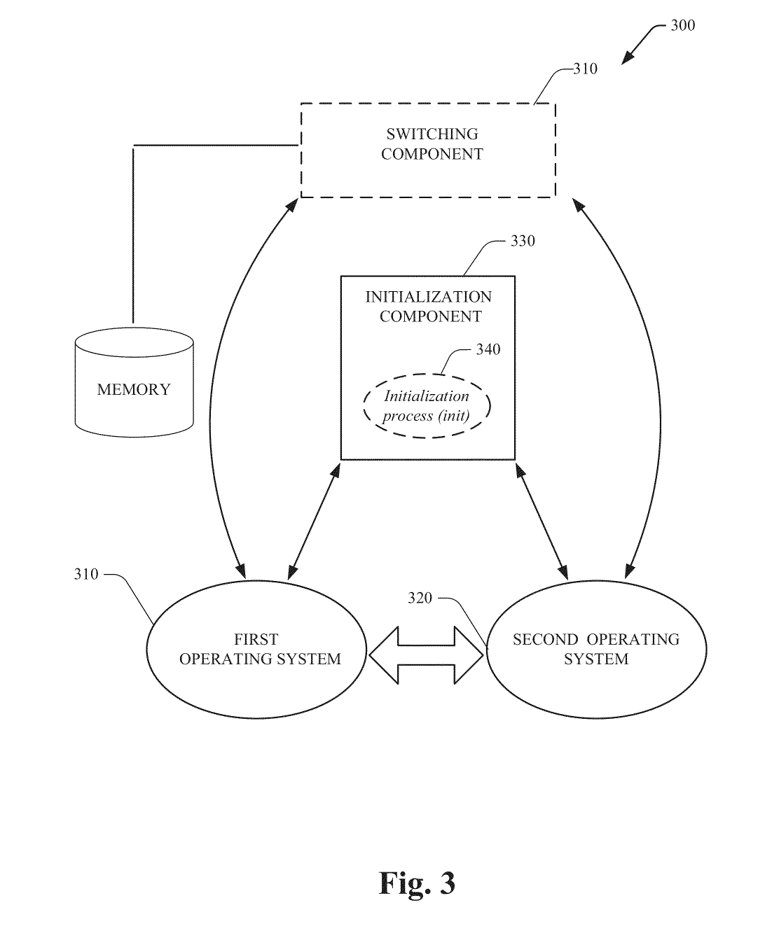

FIG. 3 illustrates a system according to an aspect of the subject disclosure, which enables switching between a first operating system 311 and a second operating system 312, via a switching component 310—which further interacts with an initialization component 330 in accordance with an aspect of the subject disclosure. Even though FIG. 3 is primarily described in context of switching between two operating systems, it is to be noted that the subject disclosure is not so limited, and switching among more than two operating systems are well within the realm of the subject disclosure.

In one aspect, the initialization component 330 can enhance upon an init process 340 (initialization—which can spawn all other processes such as by loading and executing a new child process) in Unix-based operating system; wherein a boot loader (not shown) starts a kernel that instigates such init process 340.

Subsequently, the init process 340 can attempt to shut down all processes except itself, upon receiving instruction for switching from a predefined socket. Upon receiving a ‘switch’ message from a predefined socket, the init process 340 can attempt to shut down all processes except itself. Such can be performed by broadcasting the SIGTERM signal, which can represent a signal sent to a process to request a termination thereof. System, services and applications can manage such signal by releasing all locks and resources before exiting, for example. At the same time, the init process 340 can pause for a relatively short period to ensure all processes have adequate time to quit elegantly. Such action can enable most system resource to remain in a consistent state, and hence not interfere with the new OS instance.

After the pause, the init process 340 can broadcast a SIGKILL signal to force the termination of all, remaining processes. It can subsequently save the system environment variables, wherein such saved environment variables can be employed by the run time environment, when switching back to the original or first OS. Next, the Init process 340 can turn to switch the file system name space by changing the root directory, as described below.

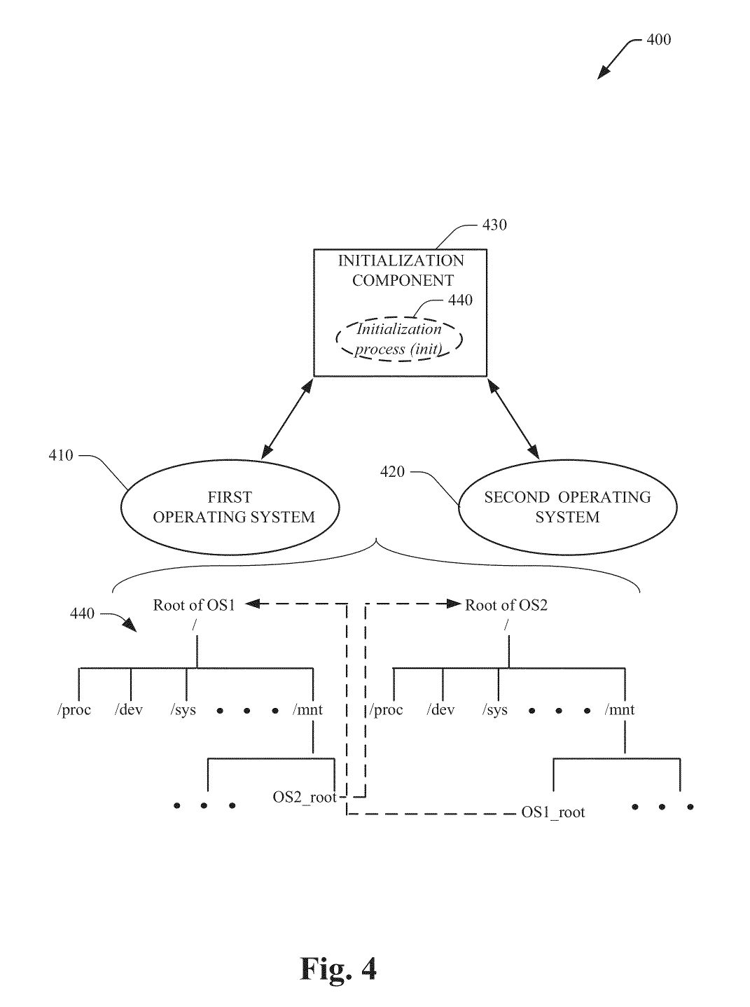

FIG. 4 illustrates an example for a system 400 that enables change of root directory and file system name space switching 440, according to an aspect of the subject innovation. In one aspect, each of the OS instances 410, 420 can have a mount point for mounting the root partition for another OS and supply the first switching, for example. The mount point can represent a physical location in the partition employed as a root file system.

In example, during a first-time switching, a file descriptor can be created for locating the root directory of the OS to be switched. Moreover, to mitigate infinite increase of the path name length, subsequent switching can be accomplished by changing root through such pre-stored file descriptor, (instead of having to operate on the mount point again.) To further save switching time, a predetermined number of virtual file systems (e.g. /proc/sys) are enabled to have duplicated instances in the directory tree. All such duplicated file systems can be mounted in advance during the initial system boot up stage, and are not to be remounted during system switching.

Subsequently, the init process for the first operating system can be followed by execution of another new init for the second OS instance. For example, resources allocated by current init (e.g., for the first operating system)—can be released before the execution (besides resources used for next switching).

In a related aspect, to execute a new program, the subject disclosure can invoke exec system call and execute new init directly—as the process number of init can be the same (e.g., “1”). The exec system call replaces the current init (associated with the first operating system) with a new init (associated with the second operating system) without changing process id, for example. Other ways to execute new program (by forking a new process) can include changing a process number, for example.

On starting execution, the new init can check whether it is running as the first round. If the current execution is not the first round, it restores the previously saved environment variables, and skips some one-time initializations, such as ‘making device nodes’. In one aspect, after new init starts up all system services for another OS instance, the switching process can end.

The above methodology of the subject disclosure can substantially improve operation times, as compared to other systems. For example, in some dual switching processes, a plurality of stages arc involved, such as: a shut-down stage, a hardware initialization stage, and a boot-up phase. In such systems, the shut-down stage of the original OS can halt all system services; sync file buffers to a disk and shut down drivers and Kernel (e.g., for some processing units, such shut-down stage can take approximately 9.3 seconds.) Similarly in the hardware initialization phase of such systems, the hardware (cache, RAM, chip set, etc.) can be initialized by BIOS—(e.g., such phase can take˜10 seconds on some units.) Likewise, in the Booting up phase of such systems, the system can load and boot-up the kernel of the new OS, loads drivers and initializes the devices, mounts file system, initializes network protocols, and starts up system services. For example, for Ubuntu™, such phase can take approximately 25 seconds on “HP Mini1000.”

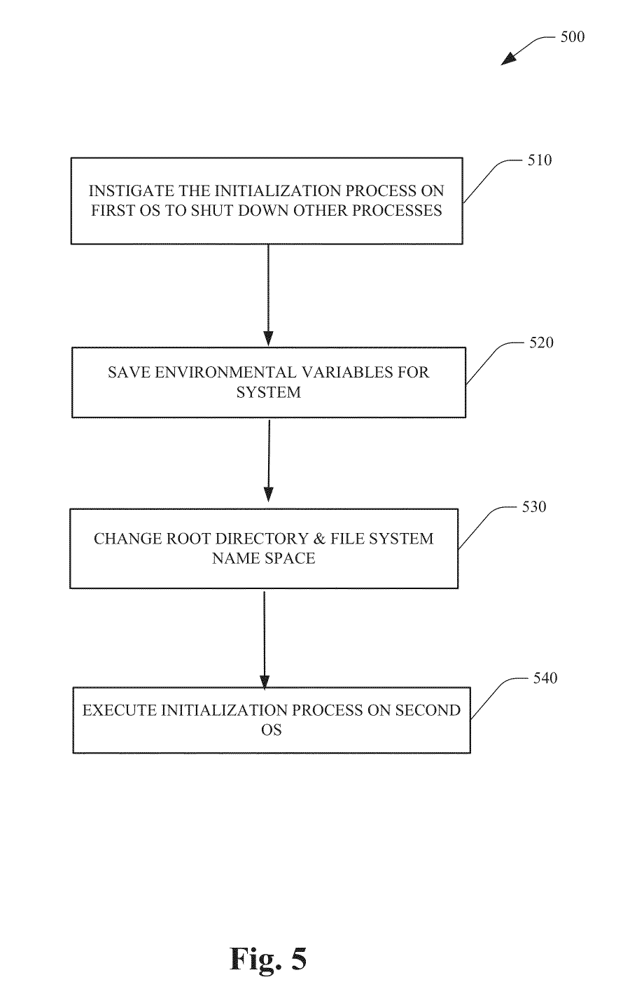

FIG. 5 illustrates a related methodology 500 of switching between operating systems according to an aspect of the subject innovation. While this example is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the subject disclosure. In addition, not all illustrated blocks, events or acts, may be used to implement a methodology in accordance with the subject innovation. Moreover, it is noted that the example method and other methods according to the innovation may be implemented in association with the method illustrated and described herein, as well as in association with other systems and apparatus not illustrated or described. The methodology 500 for dual operating system switching can substantially improve switching times between an initial OS (e.g., an original OS) and a subsequent OS (e.g., new OS) and efficiently allocate system resources (e.g., power, memory, and the like), to enhance operation of associated computer systems that are based on a same Kernel.) Initially and at 510 an init process (initialization) can be instigated, wherein such process can represent a program for Unix-based computer operating systems that spawns all other processes—(wherein, a boot loader starts a Kernel and the Kernel starts init.) As explained earlier, the init can attempt to shut down all processes except itself. For example, a SIGTERM signal can be broadcasted, which represents a signal sent to a process to request a termination thereof. Moreover, all locks and resources can be released before exiting.

In one aspect, all locks and resources can then be released before exiting, wherein, init can pause for a substantially short period to ensure all processes have adequate time to quit elegantly. Such enables a consistent state for system resources—hence avoiding interfere with the new OS instance. Subsequently and at 520, environmental variables associated the system can then be saved—wherein such environmental variables can create an operating environment in which a process runs. In addition, the saved environment variables can be employed by the run time environment, if switching back to the original OS becomes necessary.

Next and at 530, by changing the root directory—the file system name space can then be switched. At 540, the current init can turn to execute the new init for a second OS instance (e.g., the new OS being switched to.) All resources allocated by current init, (except those to be used for next switching) can be released before the execution.

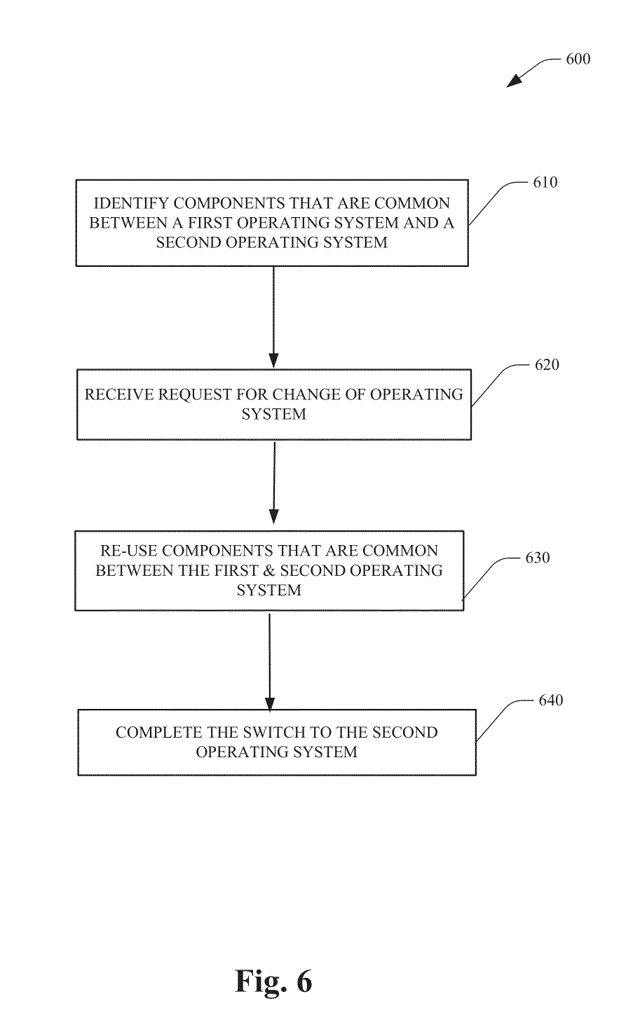

FIG. 6 illustrates a related aspect, wherein the methodology 600 can initially identify a common component(s) between a first operating system and a second operating system, at 610. For example, such common components between the first operating system and the second operating system can be associated with the same kernel, file systems, drivers, protocol stacks and the like. Subsequently, and at 620 a request for change of operating system can be received. For example, such request to change operating systems can be based on type of activity the user becomes engaged in, such as switching between web-browsing and file management.

As explained earlier, Android™ (a Linux™-kernel based OS) is often considered well designed for internet surfing, web-service accessing, touch experience, and relatively low power consumption. Nonetheless, Android™ can suffer from poor window management and lack of sufficient offline applications. On the other hand, Ubuntu™ (another Linux™-kernel based OS) can provide rich offline applications (e.g., OpenOffice) and flexible multi-window management.

However, Ubuntu™ does not supply efficient touch experience and power savings. By selectively combining benefits of the two operating systems, a user can switch (e.g., back and forth) between these OS's based on type of activity the user is engaged in (e.g., employing Android™ for web surfing). Likewise, some applications employ specific Linux™ OS, such as accessing bank accounts that use USB certificate—which can be deemed feasible for Linux™ OS. Hence, a user who surfs the internet on Android™ can benefit when switching to Ubuntu™ for bill payment, and switch back to Android™ to surf the web. At 630, the methodology 600 reuse the common components between the first operating and the second operating system to complete the switching from the first operating system to the second operating system at 640.

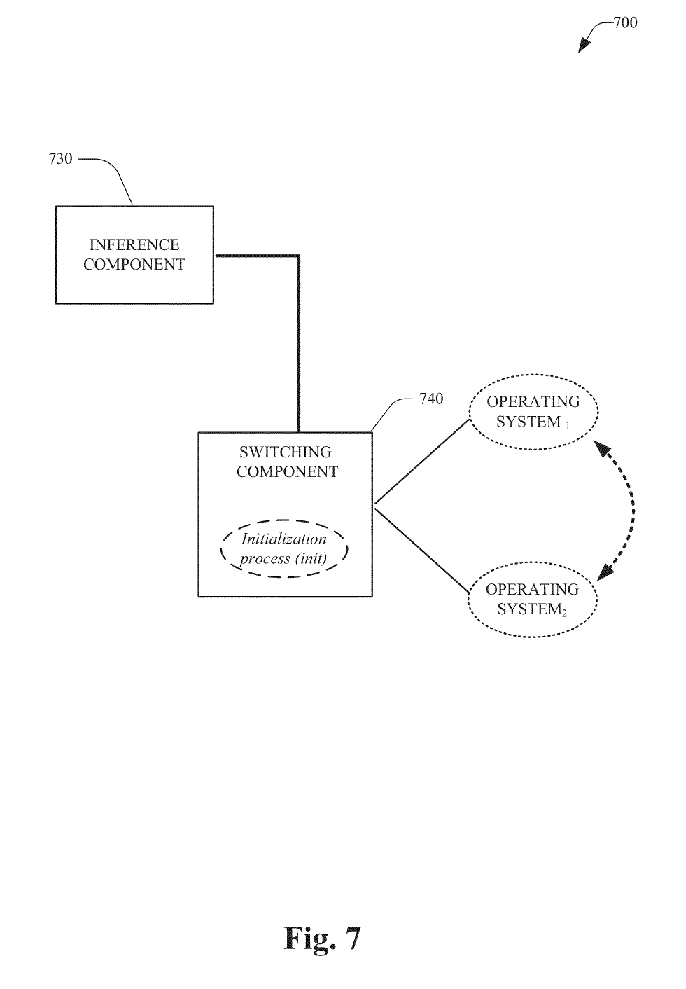

FIG. 7 illustrates a system 700 having an inference component 730 (e.g., an artificial intelligence—AI) that can interact with a switching component 740, to facilitate inferring and/or determining when, where, how to predict user activity, and hence aid switching between operating systems according to an aspect of the subject disclosure. For example, a probability that an end user's computing activities can be facilitated if switched from a first operating system to a second operating system, can be determined.

As used herein, the term “inference” refers generally to the process of reasoning about or inferring states of the system, environment, and/or user from a set Of observations as captured via events and/or data. Inference can identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The inference component 730 can employ any of a variety of suitable AI-based schemes as described supra in connection with facilitating various aspects of the herein described subject matter. For example, a process for learning explicitly or implicitly how parameters are to be created for training models based on user activities can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

The subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, SVM's can be configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

### EXAMPLE OF NETWORKED AND DISTRIBUTED ENVIRONMENTS

It is noted that the various embodiments described herein can be implemented in connection with any computer or other client or server device, which can be deployed as part of a computer network or in a distributed computing environment, and can be connected to any kind of data store where media may be found. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services can also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the various embodiments of this disclosure.

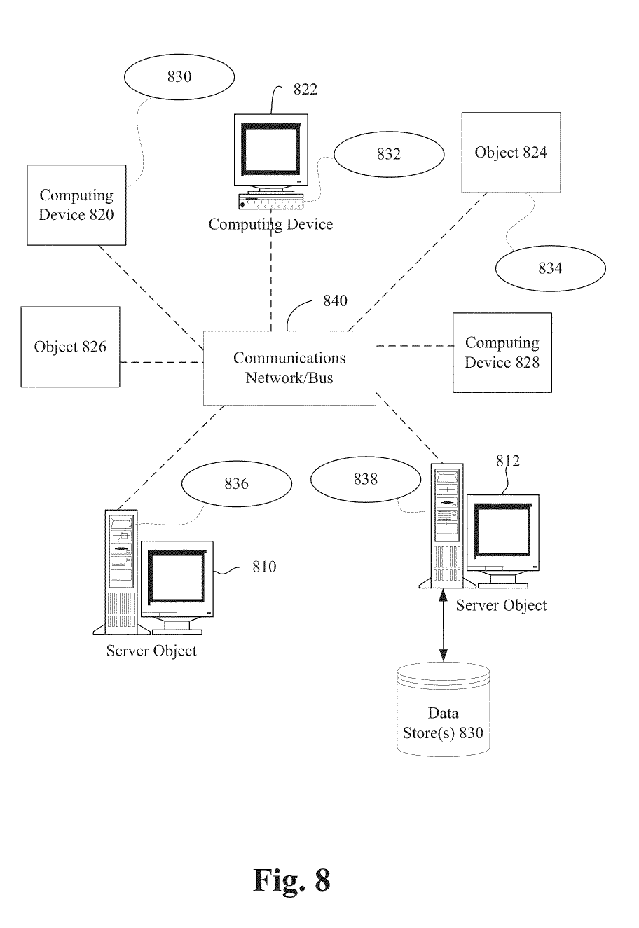

FIG. 8 provides a schematic diagram of an example for networked or distributed computing environment in which embodiments described herein can be implemented. The distributed computing environment includes computing objects 810, 812, etc. and computing objects or devices 820, 822, 824, 826, 828, etc., which can include programs, methods, data stores, programmable logic, etc., as represented by applications 830, 832, 834, 836, 838. It is noted that computing objects 810, 812, etc. and computing objects or devices 820, 822, 824, 826, 828, etc. can include different devices, such as personal digital assistants (PDAs), audio/video devices, mobile phones, MPEG-1 Audio Layer 3 (MP3) players, personal computers, laptops, tablets, etc.

Each computing object 810, 812, etc. and computing objects or devices 820, 822, 824, 826, 828, etc. can communicate with one or more other computing objects 810, 812, etc. and computing objects or devices 820, 822, 824, 826, 828, etc. by way of the communications network 840, either directly or indirectly. Even though illustrated as a single element in FIG. 8, communications network 840 can include other computing objects and computing devices that provide services to the system of FIG. 8, and/or can represent multiple interconnected networks, which are not shown. Each computing object 810, 812, etc. or computing objects or devices 820, 822, 824, 826, 828, etc. can also contain an application, such as applications 830, 832, 834, 836, 838, that might make use of an application programming interface (API), or other object, software, firmware and/or hardware, suitable for communication with or implementation of the various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used as examples of communications made incident to the systems as described in various embodiments.

Thus, a host of network topologies and network infrastructures, such as client/server, peer-to-peer, or hybrid architectures, can be utilized. The client can be a member of a class or group that uses the services of another class or group. A client can be a computer process, e.g., roughly a set of instructions or tasks, that requests a service provided by another program or process. A client can utilize the requested service without having to know all working details about the other program or the service itself.

As used in this application, the terms “component,” “module,” “system,” and the like are intended to refer to a computer-related entity, either hardware, software, firmware, a combination of hardware and software, software and/or software in execution. For example, a component can be, but is not limited to being, a process running on a processor, a processor, an object, an executable, a thread of execution, a program, and/or a computer. By way of illustration, both an application running on a computing device and/or the computing device can be a component. One or more components can reside within a process and/or thread of execution and a component can be localized on one computer and/or distributed between two or more computers. In addition, these components can execute from various computer-readable storage media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs . A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

In a client/server architecture, such as a networked system, a client can be a computer that accesses shared network resources provided by another computer, e.g., a server. In the illustration of FIG. 8, as a non-limiting example, computing objects or devices 820, 822, 824, 826, 828, etc. can be thought of as clients and computing objects 810, 812, etc. can be thought of as servers where computing objects 810, 812, etc. provide data services, such as receiving data from client computing objects or devices 820, 822, 824, 826, 828, etc., storing of data, processing of data, transmitting data to client computing objects or devices 820, 822, 824, 826, 828, etc., although any computer can be considered a client, a server, or both, depending on the circumstances. Any of these computing devices can process data, or request transaction services or tasks that can implicate the techniques for systems as described herein for one or more embodiments.

A server can be represented by a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects:

In a network environment in which the communications network/bus 840 can be the Internet, for example, the computing objects 810, 812, etc. can be Web servers, file servers, media servers, etc. with which the client computing objects or devices 820, 822, 824, 826, 828, etc. communicate via any of a number of known protocols, such as the hypertext transfer protocol (HTTP). Computing objects 810, 812, etc. can also serve as client computing objects or devices 820, 822, 824, 826, 828, etc., as can be characteristic of a distributed computing environment.

### EXAMPLE OF COMPUTING DEVICE

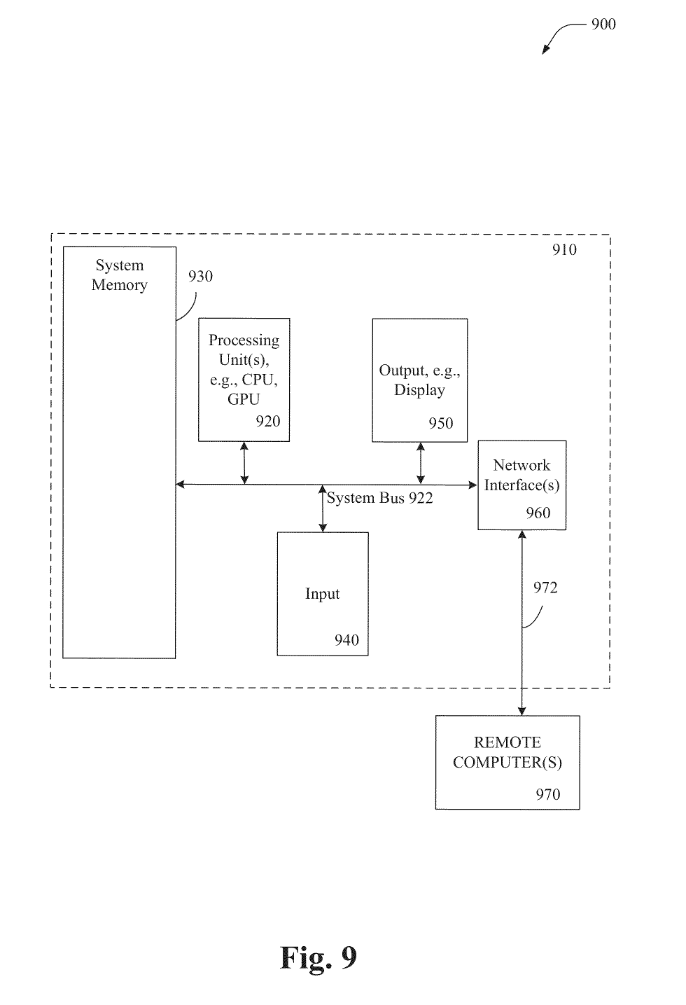

As mentioned, advantageously, the techniques described herein can be applied to any suitable device. It is to be understood, therefore, that handheld, portable and other computing devices and computing objects of all kinds are contemplated for use in connection with the various embodiments, e.g., anywhere that a device may wish to read or write transactions from or to a data store. Accordingly, the below remote computer described below in FIG. 9 is but one example of a computing device. Additionally, a suitable server can include one or more aspects of the below computer, such as a media server or other media management server components.

Embodiments can be partly implemented via an operating system, for use by a developer of services for a device or object, and/or included within application software that operates to perform one or more functional aspects of the various embodiments described herein. Software can be described in the general context of computer executable instructions, such as program modules, being executed by one or more computers, such as client workstations, servers or other devices. It is noted that computer systems have a variety of configurations and protocols that can be used to communicate data, and thus, no configuration or protocol is to be considered limiting.

FIG. 9 thus illustrates an example of a suitable computing environment 900 in which one or aspects of the embodiments described herein can be implemented, although as made clear above, the computing environment 900 is only one example of a suitable computing environment and is not intended to suggest any limitation as to scope of use or functionality. Neither is the computing environment 900 to be interpreted as having any dependency relating to any one or combination of components illustrated in the example of computing environment 900.

With reference to FIG. 9, an example of computing environment 900 for implementing various aspects includes a computing device in the form of a computer 910 is provided. Components of computer 910 can include, but are not limited to, a processing unit 920, a memory 930, and a system bus 922 that couples various system components including the system memory to the processing unit 920. Computer 910 can for example implement systems and/or components described in connection with various aspect of the subject disclosure.

Computer 910 can include a variety of computer readable media and can be any available media that can be accessed by computer 910. The memory 930 can include computer storage media in the form of volatile and/or nonvolatile memory such as read only memory (ROM) and/or random access memory (RAM). By way of example, and not limitation, memory 930 can also include an operating system, application programs, other program modules, and program data.

A user can enter commands and information into the computer 910 through input devices 940, non-limiting examples of which can include a keyboard, keypad, a pointing device, a mouse, stylus, touchpad, touch screen, trackball, motion detector, camera, microphone, joystick, game pad, scanner, video camera or any other device that allows the user to interact with the computer 910. A monitor or other type of display device can be also connected to the system bus 922 via an interface, such as output interface 950. In addition to a monitor, computers can also include other peripheral output devices such as speakers and a printer, which can be connected through output interface 950.

The computer 910 can operate in a networked or distributed environment using logical connections to one or more other remote computers, such as remote computer 970. The remote computer 970 can be a personal computer, a server, a router, a network PC, a peer device or other common network node, or any other remote media consumption or transmission device, and can include any or all of the elements described above relative to the computer 910. The logical connections depicted in FIG. 9 include a network 972, such local area network (LAN) or a wide area network (WAN), but can also include other networks/buses e.g., cellular networks.

As mentioned above, while examples of embodiments have been described in connection with various computing devices and network architectures, the underlying concepts can be applied to any network system and any computing device or system in which it is desirable to publish or consume media in a flexible way.

Also, there are multiple ways to implement the same or similar functionality, e.g., an appropriate API, tool kit, driver code, operating system, control, standalone or downloadable software object, etc. which enables applications and services to take advantage of the techniques detailed herein. Thus, embodiments herein are contemplated from the standpoint of an API (or other software object), as well as from a software or hardware object that implements one or, more aspects described herein. Also, various embodiments described herein can have aspects that are wholly in hardware, partly in hardware and partly in software, as well as in software.

Computing devices can include a variety of media, which can include computer-readable storage media and/or communications media, in which these two terms are used herein differently from one another as follows. Computer-readable storage media can be any available storage media that can be accessed by the computer, can be of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, electrically erasable programmable read only memory (EEPROM), flash memory or other memory technology, compact disc read only memory (CD-ROM), digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media can embody computer-readable instructions, data structures, program modules or other structured or unstructured data in a data signal such as a modulated data signal (e.g., a carrier wave or other transport mechanism) and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, radio frequency (RF), infrared and other wireless media.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessor and/or other electronic units designed to perform the functions described herein, or a combination thereof.

When the embodiments are implemented in software, firmware, middleware or microcode, program code or code segments, they can be stored in a machine-readable medium (or a computer-readable storage medium), such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules or components (e.g., procedures, functions, and so on) that perform the functions described herein. The software codes can be stored in memory units and executed by processors. A memory unit can be implemented within the processor or external to the processor, in which case it can be communicatively coupled to the processor via various structures.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

What has been described above includes examples of one or more embodiments. It is, of course, not possible to describe every conceivable combination of components or methodologies for purposes of describing the aforementioned embodiments, but one of ordinary skill in the art can recognize that many further combinations and permutations of various embodiments are possible. Accordingly, the described embodiments are intended to embrace all such alterations, modifications and variations that fall within the spirit and scope of the appended claims:

The aforementioned systems have been described with respect to interaction between several components. It is noted that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components can be combined into a single component providing aggregate functionality or divided into several separate sub-components, and that any one or more middle layers, such as a management layer, can be provided to communicatively couple to such sub-components in order to provide integrated functionality. Any components described herein can also interact with one or more other components not specifically described herein but generally known by those of skill in the art.

In view of the exemplary systems described above methodologies that can be implemented in accordance with the described subject matter can be better understood with reference to the flowcharts of the various figures. While for purposes of simplicity of explanation; the methodologies are shown and described as a series of blocks, it is to be understood and noted that the claimed subject matter is not limited by the order of the blocks, as some blocks can occur in different orders and/or concurrently with other blocks from what is depicted and described herein. Where non-sequential, or branched, flow is illustrated via flowchart, it is noted that various other branches, flow paths, and orders of the blocks, can be implemented which achieve the same or a similar result.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be affected across a plurality of devices. The invention is not to be limited to any single embodiment, but rather can be construed in breadth, spirit and scope in accordance with the appended claims.

What is claimed is:

1. A system that switches a first operating system (OS) of a computing unit, to a second OS, comprising:
a kernel component that is shared between the first OS and the second OS; and
a switching component that switches the computing unit from the first OS to the second OS, based on re-using the kernel component.

2. The system of claim 1, wherein the switching component further comprises a restoration component that at least one of saves or restores environmental variables for an OS.

3. The system of claim 1, wherein the first operating system and the second operating system are Linux™ based.

4. The system of claim 3, wherein the switching component further comprises an initialization component that enhances an init process.

5. The system of claim 2 further comprising a mount point for mounting a root partition of the OS.

6. The system of claim 5 further comprising a file descriptor that locates a root directory of the OS.

7. The system of claim 5 further comprising an inference component that facilitates switching between the first OS and the second OS based on user'activities.

8. A method of switching between a first operating system and a second operating system comprising:
executing an initialization command for the first operating system;
reusing at least one of: a kernel; or a driver; or a file system that is common between the first operating system and the second operating system, to switch to the second operating system; and
executing an initialization command for the second operating system.

9. The method of claim 8 further comprising identifying root directories associated with the first operating system and the second operating system.

10. The method of claim 9 further comprising saving environmental variables of the first OS, for use by a run time environment when returning to the first OS.

11. The method of claim 10 further comprising duplicating instances of virtual files for mounting in an initial system boot up stage.

12. The method of claim 10 further comprising changing a root directory from the first operating system to the second operating system.

13. The method of claim 10 further comprising inferring user activities for switching between user activities.

14. The method of claim 10 further comprising employing a Linux™ based kernel for the re-using act.

15. A non-transitory computer readable medium that comprises commands that if executed by a processor in a computing device cause the computing device to:
save environment variables associated with a first OS;
change a root directory from the first OS to a second OS;
execute an initialization command for the second OS; and
switch environment variables to that of the second OS.
